(19) United States
(12) Patent Application Publication
(10) Pub. No.: US 2018/0341954 A1
(43) Pub. Date: Nov. 29, 2018

(54) METHOD AND SYSTEM FOR MANAGEMENT OF INTERNET SEARCH MARKETING CAMPAIGNS

(71) Applicant: Bond IP Holdings Pty Ltd, Norman Park, Queensland (AU)

(72) Inventor: Shaun Bond, East Brisbane (AU)

(73) Assignees: Bond IP Holdings Pty Ltd, Norman Park, Queensland (AU); Bond IP Holdings Pty Ltd, Norman Park, Queensland (AU)

(21) Appl. No.: 15/755,939

(22) PCT Filed: Aug. 26, 2016
(86) PCT No.: PCT/AU2016/050797

§ 371 Date: Feb. 27, 2018

(30) Foreign Application Priority Data
Aug. 27, 2015 (AU) AU 2015903466

(51) Int. Cl. G06Q 30/02

(52) U.S. Cl. CPC G06Q 30/02

(57) ABSTRACT

A method or system for management of internet search marketing campaigns, comprising software which contains at least one of the following features: (a) a process flowcharting feature by which a user can develop in a graphical manner the applicable campaign management process for an internet search marketing campaign; and (b) a process flowcharting feature by which the need for a user to develop mathematical formulas or write software code to analyse available campaign data is removed.

### TECHNICAL FIELDS

The technical fields of the invention are: internet search marketing, internet-based advertising campaigns, tools for management and optimisation of internet search advertising and marketing campaigns, tools for management and optimisation of pay-per-click advertising.

### BACKGROUND OF THE INVENTION

Internet users use internet search providers such as Google to search for internet content of interest, including when researching purchase decisions.

It is valuable to advertisers to display relevant advertising when a user searches for a particular word or topic. Advertisers pay search providers to display particular advertising to users when particular terms are searched for.

For example, internet users that have an interest in purchasing televisions may search for the term “television” using an internet search provider such as Google. An advertiser such as a television manufacturer may wish to display advertising to such users, with a view to influencing the users' purchasing decisions. The advertiser may therefore arrange with the search provider, for a fee, to display its advertising to each user that searches for the term “television.” The advertising appears alongside the non-advertising (“organic”) search results generated by the search provider. Typically, the advertising consists of brief copy and links to relevant parts of the advertiser's own web site.

Typically, a fee will only be charged by the search provider to the advertiser when a user clicks on (and hence follows a link to) the relevant advertising. The fee is therefore described and analysed in terms of a “cost per click” and the style of advertising is described as “pay per click.”

The fee charged by the search provider to the advertiser will vary depending, among other things, on the number of competing advertisers that may wish to display advertising in response to a particular search term. Popular search terms among advertisers will have a higher cost per click.

A common approach by search providers is to allow advertisers to bid to advertise for particular search terms, with various automatic systems in place to determine which advertiser is entitled to display advertising for each use of the targeted search term.

Advertisers typically select a number of different search term trigger words and phrases for a particular advertising campaign. Advertisers must settle advertising copy and web site end-points for their advertising links. Advertisers must settle bids and budgets for each search term and overall. Advertisers may also need to decide other aspects of their campaign such as whether the campaign is targeted to specific geographies. Many other options may be available, depending on the search provider and automated system in use.

Further, during and after an advertising campaign, data will be available to the advertiser about the operation, performance and cost of the campaign. Such data includes the total number of advertisement displays triggered by the selected search terms (“impressions”), the proportion of such displays where users click on and follow the relevant advertisement link (“clicks”), the cost incurred by the advertiser for each such click (“click costs”), and so on. Changes to the campaign may be made based on analysis of the data available.

Sophisticated online search marketing campaigns therefore require detailed planning and management, both before and during the course of a campaign.

The present invention comprises a software-based method and system providing tools to assist individual advertisers (or advertising agents, consultants or campaign managers managing campaigns on behalf of multiple individual advertisers—herein together described as “agents”) to plan and manage internet search based advertising campaigns. There are other such internet search based advertising management systems known in the field, however they have significant limitations that the present invention overcomes.

The primary problems with current state of the art are as follows:

### 1. Lack of Flexibility

At present the internet search based advertising management systems known to the art are significantly limited by their lack of flexibility. They are limited in their ability to allow the advertiser to create complex, personalized management tasks for each client or campaign, and similarly have a limited ability to automate some or all of these tasks. Systems known to the art also usually have predetermined algorithms with a limited ability for the advertiser or agency to change the inputs at their discretion in response to their needs (or, if an agency, the needs of their advertiser clients).

### 2. Complex Formula Writing or Coding Required

At present, it is known in the art within some existing systems for the advertiser or agent to have the capacity to automate management tasks through the use of a mathematical formula (similar to a formula that would be used in a spreadsheet) or to develop software code (known as a script). This is problematic, because using scripts or mathematical formulas as part of the development of automation rules requires the advertiser or agent to possess a strong understanding of appropriate mathematical formula construction or software scripting. It is also easy for an advertiser or agent to make a mistake in a complex formula or script, and is subsequently difficult to troubleshoot for the advertiser if the campaign is not functioning as the advertiser expects due to such an error. Errors can cost advertisers in terms of time spent debugging the script or formulas, in addition to real costs incurred through clicks generated as a result of undetected bugs or flaws in the automation logic.

### SUMMARY OF THE INVENTION

The present invention comprises a software-based method and system providing tools to assist individual advertisers and agents, to plan and manage internet search based advertising campaigns through the use of automation. There are other such management systems known in the field, however they have significant limitations, such as those discussed above, that the present invention overcomes.

### Solution to Problem 1: Lack of Flexibility

The present invention removes the problems described in the section on ‘lack of flexibility’ above by providing a ‘drag and drop’ process flowcharting engine. The ‘drag and drop’ process flowcharting engine allows the advertiser or agency to develop an advertising campaign management process out of any combination of statistical input data (available through a standard software communication interface or “API”) and then to automate part or all of that process at their discretion according to their chosen schedule. The advertiser or agent can effectively build a flowchart that represents the desired logic and workflow, using the available data fields in any way they determine as appropriate, followed by various ‘actions’ depending upon the results of that analysis. No other solution known in the art at the priority date provides the user with the ability to build an automated workflow via a flowchart.

The implementation of ‘actions’ can be either fully automated (where the analysis and ‘actions’ are completed automatically in accordance with the advertiser's settings), partially automated (where some ‘actions’ are automated and some ‘actions’ are reserved for manual checking before processing) or manually (all ‘actions’ are reserved and presented to the advertiser for checking before processing).

This enhances flexibility for the advertiser or agent, as they can specify exactly which statistical metrics should be analysed for the purpose of evaluating particular aspects of a search advertising campaign, precisely when and how often that analysis should occur, what actions should be implemented depending upon the outcome of that analysis, and automate as much or as little of the process as required.

This aspect of the present invention advances the state of the art by ensuring the advertiser or agent can meet the differing needs of businesses advertising in the online search marketing environment in a more customised and efficient manner than those currently known to the art. In the present invention there are no predetermined processes for developing campaigns; the advertiser or agent effectively builds their own customised process through the easy ‘drag and drop’ interface to suit the individual needs of the advertiser. The advertiser or agent can use those processes as templates and apply them across multiple advertiser accounts as appropriate. Sample templates are provided to assist the advertiser or agent to initialise a campaign.

### Solution to Problem 2: Complex Formula Writing or Coding Required

The ‘drag and drop’ flowchart engine removes the need for advertisers or agents to be able to articulate complex mathematical formulas or write scripts. The simplified visual interface is also less cumbersome to manipulate and easier to troubleshoot than the current state of the art.

### BRIEF DESCRIPTION OF FIGURES

FIG. 1 is an example of a workflow that has been built in the application being one of the preferred embodiments of the invention—this particular workflow is designed to take search queries that have been used by website visitors to find and click on an advertiser's advertisements, and add them into the account as new keywords for the advertiser to bid on (to better target and capture future searches).

### DESCRIPTION OF EMBODIMENTS

It is convenient to describe the invention in terms of preferred embodiments. However, the preferred embodiments are not to be construed as limiting the scope of the invention. The invention is applicable to a range of circumstances, and it is to be appreciated that other approaches to and embodiments of the invention are also to be considered as falling within the scope of the invention.

In one embodiment of the present invention, an advertiser or agent is provided with a list of statistical metrics obtained by software through an API interface (in a manner well-known in the field of software engineering) that is connected to the advertiser's advertising platform available from the relevant internet search provider (for example. Google Adwords). The advertiser or agent then selects which metrics they require their process to analyse, followed by the appropriate ‘actions’ to take if the process conditions are met. The advertiser or agent also specifies which campaigns the process is to analyse, and on what schedule if applicable. Software implements those selections and specifications in the manner known in the field of software engineering.

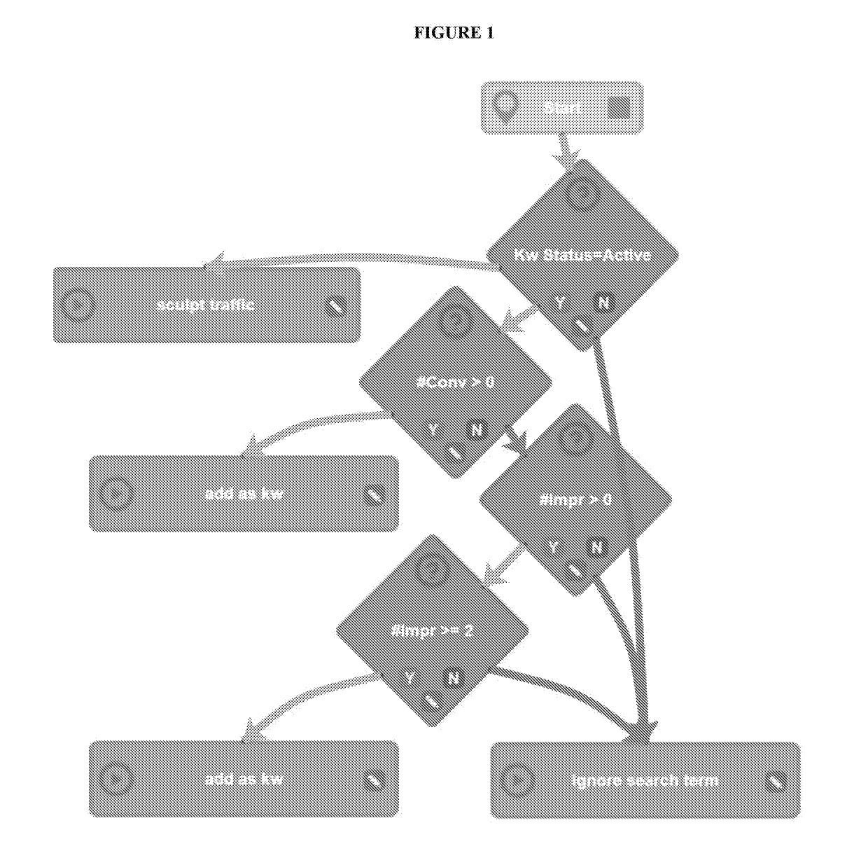

FIG. 1 shows a screenshot of the workflow from the application.

This embodiment of the invention allows the advertiser or agent greater flexibility in both their choice of metrics to assess and actions to take in response. Both metrics and actions are represented to the advertiser or agent by flowchart graphics in a drag-and-drop fashion, that is, which representational graphics respond to being inserted into the process, adjusting the process accordingly, thereby providing the advertiser or agent with an easily managed approach to manipulating campaign elements. Each metric poses a yes/no question, which is then linked to the next metric question or action by green or red arrows that represent yes and no answers. There is software programming behind the visual interface to make these choices simple to develop for the advertiser or agent, removing the need for complex formula writing or custom software writing by the advertiser or agent. The software programming, though significant and complex, is undertaken in a manner known to the art of software engineering, given the embodiment described above.

Modifications may be made to the specific embodiments described above without departing from the scope of the invention described in this specification.

1-4 (canceled)

5. A method or system for management of internet search marketing campaigns, comprising software which contains at least one of the following features: (a) a process flowcharting feature by which a user can develop in a graphical manner the applicable campaign management process for an internet search marketing campaign; and (b) a process flowcharting feature by which the need for a user to develop mathematical formulas or write software code to analyse available campaign data is removed.

6. The method or system in claim 5 in which the process flowcharting feature allows for inputs and analysis of various campaign data, decision-making about such inputs, and various actions depending on the result of the analysis.

7. The method or system in claim 5 in which the actions taken as a result of data analysis can be partly or fully automated.

8. The method or system in claim 6 in which the actions taken as a result of data analysis can be partly or fully automated.

9. The method or system in claims 5 in which the graphical process flowcharting user interface is a “drag and drop” user interface.

10. The method or system in claims 6 in which the graphical process flowcharting user interface is a “drag and drop” user interface.

11. The method or system in claims 7 in which the graphical process flowcharting user interface is a “drag and drop” user interface.

12. The method or system in claims 8 in which the graphical process flowcharting user interface is a “drag and drop” user interface.
